(19) United States
(12) Patent Application Publication
(10) Pub. No.: US 2002/0067763 A1
(43) Pub. Date: Jun. 6, 2002

(54) Method of and apparatus for data transmission computer product

(76) Inventors: Noriyasu Suzuki, Yokohama (JP); Yoichi Ueda, Yokohama (JP)

Correspondence Address: ROSENMAN & COLIN LLP, 575 MADISON AVENUE, NEW YORK, NY, 10022-2585, US

(21) Appl. No.: 09/837,955

(22) Filed: Apr. 19, 2001

(30) Foreign Application Priority Data
Dec. 4, 2000 (JP) 2000-369211

(51) Int. Cl. H04B 1/38; H04L 5/16

(52) U.S. Cl. 375/219

(57) ABSTRACT

Data are transmitted only at FEXT interval. Data transmission is stopped at NEXT interval. Concretely, in a dual bit map system, a NEXT-use bit map is set so that the transmission rate becomes zero. This setting is forcibly done on a receiving side where the bit map is created. Moreover, while the data transmission is being stopped, the operation of the transmission digital filter, transmission analog filter and the like of an xDSL modem is stopped to avoid wasteful power consumption.

### FIELD OF THE INVENTION

This invention relates to a method of and apparatus for data transmission capable of realizing data transmission in which energy efficiency is excellent.

### BACKGROUND OF THE INVENTION

Recently, as a network represented by internet is abruptly spread, it is strongly required to heighten a speed of communication. High-speed communication is difficult with metal wiring (copper wire), and thus it is unexpendable for legitimate high-speed communication to structure an optical fiber network. In the case where a metal wiring is used, only data transmission of about 55.6 Kbps in analog communication, and data transmission of about 64 Kbps in digital communication represented by ISDN are spread as matters stand. However, it takes a long time until an optical fiber is laid down throughout Japan, and this has a lot of problems from the viewpoint of costs.

Under such a situation, an attention is paid to xDSL technique. The xDSL (Digital Subscriber Line) technique enables high-speed communication (up to several Mbps) by using a frequency bandwidth, which is higher than a bandwidth used for sound signal communication, in data transmission.

In this xDSL, since a bandwidth which is different from a bandwidth (up to 4 KHz) used for sound communication is used for data transmission, the data transmission can coexist with sound call by means of a telephone. Namely, the xDSL has a great advantage that one set (two) metal wirings enable both sound call and data transmission simultaneously. This is flattering also from the viewpoint of continuous connection to a network. Moreover, frequencies of a carrier are shifted from each other in an up direction and in a down direction so that one set of metal wirings enable also two-way data transmissions simultaneously.

Further, in the xDSL, transmission speeds are asymmetric in the up and down directions, but this does not become a problem from the viewpoint of a characteristic of the transmission speed required for internet which is a main purpose.

Such an excellent xDSL has a problem that it is easily influenced by ISDN in Japan. This is because a frequency bandwidth to be used in ISDN is partially overlapped with a frequency bandwidth to be used for xDSL. There will be explained below this problem.

An influence which is exercised on xDSL by ISDN is divided into an influence due to a noise mixed on a receiving side of xDSL (NEXT: near end cross talk) and an influence due to a noise mixed on a transmission side of xDSL (FEXT: far end cross talk). The noise mixing (NEXT) on the receiving side has a great influence (S/N lowering width is large) because a position where a noise is mixed is close to the receiving side. On the contrary, the noise mixing on the transmission side (FEXT) has a small influence (S/N lowering width is comparatively small) because a position where a noise is mixed is far from the receiving side. The lowering of S/N causes lowering of a transmission rate. The influences of a noise should be evaluated based on a state of a signal (data) observed on the receiving side. Therefore, NEXT and FEXT are concepts only on the basis of the side which receives a signal (data).

In addition, it is widely known that the influence which is exercised on xDSL by ISDN changes periodically, more concretely NEXT and FEXT appear alternatively every period which is half a cycle of an ISDN signal (see FIG. 9) There will be explained below this point with reference to FIG. 10.

NEXT and FEXT are generated alternatively in such a manner because a so-called ping-point transmission system is adopted as a signal transmission system in ISDN of Japan. Namely, a noise is mixed in a portion of xDSL where a signal of ISDN is strong (namely, a transmission side of ISDN). In the ping-pong transmission system, the transmission direction of data is switched every predetermined period (time slot) so that the two-way communication is realized with one set of metal wirings (two). Namely, in ISDN, the transmission side and the receiving side are alternatively switched every predetermined period. For this reason, as for the influence which is exercised on xDSL, a time interval that a noise is loud and a time interval that a noise is low are generated alternatively every predetermined time (time slot). Namely, transition of the communication state between a state A and a state B in FIG. 10 is continued every predetermined cycle.

Such a problem is remarkable in the case where a signal wiring of xDSL and a signal wiring of ISDN are laid down adjacently. If both the signal wirings are separated from each other to a certain extent, the influence is small. For this reason, the arrangement of both the signal wirings is devised so that the above-mentioned problem is avoided as matters stand. However, under the present situation in which ISDN is spread to a certain extent, in the case where xDSL will be further spread in the future, the above-mentioned problem is unavoidable. In Annex C in ADSL which is laid down after such a condition peculiar to Japan is mainly considered, a technique for adjusting a transmission rate every time slot so that ISDN and xDSL coexist is suggested.

At present, in addition to heightening of the communication speed, lowering of a dissipation power is required in various equipments from the viewpoint of prevention of global warming. Such a situation is not exceptional for computer and communication equipment. For this reason, not only high-speed data transmission but also more efficient data transmission is required from the viewpoint of dissipation energy.

### SUMMARY OF THE INVENTION

It is an object of the present invention to provide a method of and apparatus for data transmission which realizes data transmission with excellent energy efficiency. It is another object of this invention to provide a computer readable recording medium that stores a computer program which when executed realizes the method according to the present invention.

In the data transmission apparatus according to one aspect of this invention a measuring unit measures a state of a line. Thereafter, a transmission rate determining unit determines a transmission rate. In this case, the transmission rate is determined based on the measured result of the measuring unit at an interval that a noise level is low (i.e. FEXT interval). Meanwhile, the transmission rate is determined as zero at an interval that the noise level is high (i.e. NEXT interval). Then, a posting unit posts the transmission rate determined in such a manner to a transmission side. Then, a receiving unit receives data transmitted via the line at the transmission rate determined by the transmission rate determining unit.

According to the above-mentioned aspect, data can be transmitted only at the interval that the noise level is low, namely, an interval that the transmission rate can be set comparatively high. Therefore, efficient data transmission is possible from the viewpoint of energy efficiency.

In the data transmission method according to another aspect of this invention, a noise level is evaluated and data are transmitted at a transmission rate which is determined based on the evaluated result at an interval that a noise level is low. Meanwhile, the transmission rate is set to zero at an interval that a noise level is high so that data are not transmitted.

According to the above-mentioned aspect, data are transmitted only at the interval that the noise level is low, namely, an interval that the transmission rate can be set to be comparatively high. For this reason, efficient data transmission is possible from the viewpoint of energy efficiency.

In the data transmission method according to still another aspect of this invention, data transmitted via a line are received in the following manner under a noise environment that two time spaces having different noise levels appear alternatively. At first, a state of the line is determined. A transmission rate is determined based on the measured result at an interval of the intervals that the noise level is low. Meanwhile, the transmission rate is set to zero at an interval that the noise level is high. Thereafter, the transmission rates determined in such a manner are posted to the transmission side. Moreover, data are received at the transmission rate posted to the transmission side.

According to the above-mentioned aspect, data are transmitted at the interval that the noise level is low, namely, an interval that the transmission rate can be set to be comparatively high. For this reason, efficient data transmission is possible from the viewpoint of the energy efficiency.

In the data transmission apparatus according to still aspect of this invention, at the time of starting communication, a measuring signal transmission unit transmits a measuring signal to the receiving side. This measuring signal is used properly according to the intervals. Namely, a predetermined receivable signal is transmitted as a measuring signal at the interval that the noise level is low. Meanwhile, unreceivable abnormal data are transmitted as a measuring signal at the interval that the noise level is high. After the measuring signal is transmitted, transmission unit transmits data to be transmitted via the line at the transmission rate posted from the receiving side.

According to the above-mentioned aspect, the transmission rate can be set to zero at the interval that the noise level is high by positively operating from the transmission side. Therefore, the energy efficiently not only the transmission side but also the receiving side can be heightened.

In the data transmission method according to still another aspect of this invention, communication is executed in the following manner in a noise environment that two time spaces having different noise levels appear alternatively. Namely, the measuring signal is transmitted at the time of starting communication and is measured so that a situation of the line is measured. Data are transmitted at the transmission rates which are determined for each interval based on the measured result. In this case, at the time of the measurement, a predetermined receivable signal is transmitted at the interval that the noise level is low. Meanwhile, unreceivable abnormal data are transmitted at the interval that the noise level is high.

According to the above-mentioned aspect, the transmission rate can be set to zero at the interval that the noise is high by positively operating from the transmission side (concretely, unreceivable abnormal data are transmitted). Therefore, the energy efficiency not only the transmission side but also the receiving side can be heightened.

In the data transmission method according to still another aspect of this invention, at the time of starting communication, a measuring signal is transmitted to the receiving side. Concretely, the following is used as the measuring signal. A receivable predetermined signal is used as the measuring signal at the interval that the noise level is low. Meanwhile, unreceivable abnormal data are used as the measuring signal at the interval that the noise level is high. After the measuring signal is transmitted, data are transmitted via the line at the transmission rate posted from the receiving side.

According to the above-mentioned aspect, the transmission rate can be set to zero at the interval that the noise is high by positively operating from the transmission side (concretely, unreceivable abnormal data are transmitted). Therefore, the energy efficiency not only on the transmission side but also on the receiving side can be heightened.

The computer readable recording medium according to another aspect of the present invention stores a computer program which when executed realizes the method according to the present invention.

Other objects and features of this invention will become apparent from the following description with reference to the accompanying drawings.

### BRIEF DESCRIPTION OF THE DRAWINGS

FIG. 1 is a block diagram showing an internal structure of an information processing apparatus according to a first embodiment of the present invention;

FIG. 2 is a block diagram showing an internal structure of an xDSL modem;

FIG. 3 is a flow chart showing an outline of a communication operation;

FIG. 4 is a flow chart showing an outline of initialization;

FIG. 5 is a flowchart showing details of S/N measuring sequence;

FIG. 6 is a flow chart showing an operation during data communication on a transmission side;

FIG. 7 is a flow chart showing an operation during data communication on a receiving side;

FIG. 8 is a flow chart showing an processing operation on the transmission side at the time of initialization in a second embodiment of the present invention;

FIG. 9 is a time chart showing periodicity of a noise; and

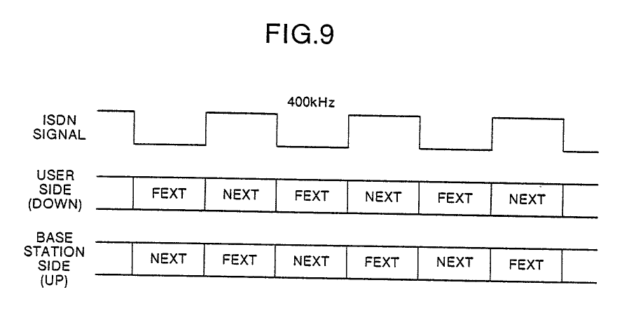

FIG. 10 is a schematic diagram showing a situation of a line during communication.

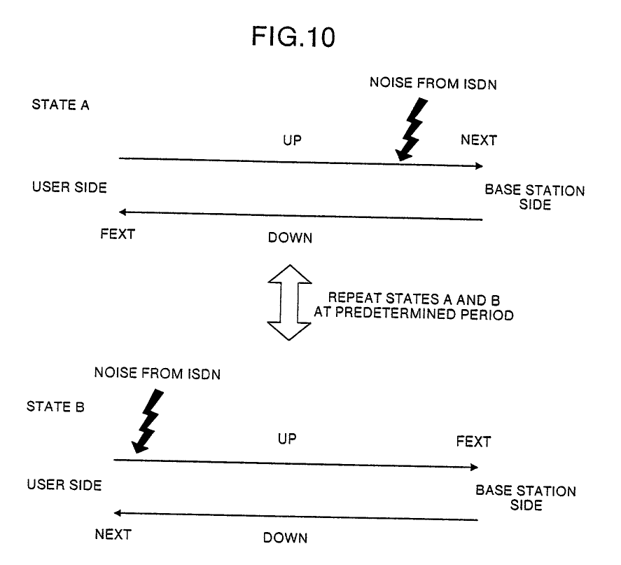

### DESCRIPTION OF THE PREFERRED EMBODIMENTS

Preferred embodiments of the present invention will be explained below with reference to the accompanying drawings. However, this invention is not to be limited to these embodiments.

A first embodiment is an information processing apparatus having xDSL modem adopting DMT (Discrete Multitone Transmission) system to modulation/coding, and this embodiment is mainly characterized in that efficient data transmission is realized by stopping transmission of data at an interval that a transmission rate is low (more concretely, NEXT interval), namely, a data transmission amount per dissipation power is heightened. In the first embodiment, this is realized by forcibly setting a NEXT-use bit map to zero by a receiving side depending on the situation. Moreover, the receiving side is characterized in that operations of various filters are stopped for an interval that data are not transmitted and thus dissipation power is reduced. The details will be explained.

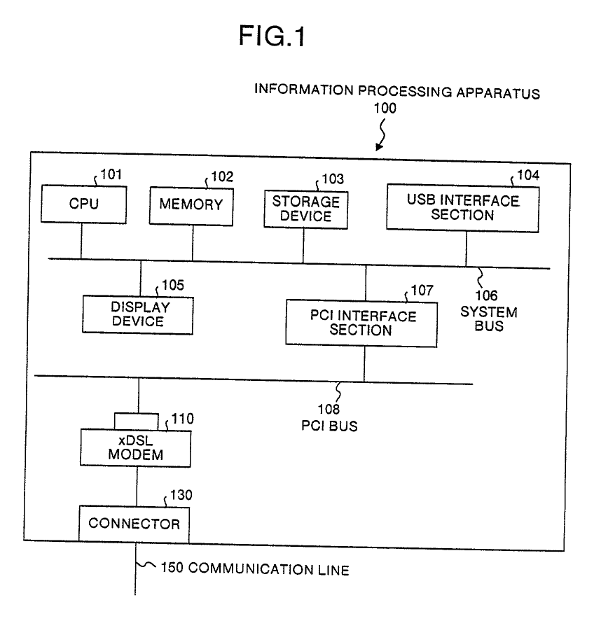

An information processing apparatus 100 of the first embodiment, as shown in FIG. 1, has a CPU 101, a memory 102, a storage device 103, a USB interface section 104 and a display device 105, and they are connected to one another by a system bus 106. Not shown in the drawing, the USB interface section 104 is connected with input devices such as a mouse and a keyboard. Moreover, the information processing apparatus 100 has a PCI interface section 107 and a PCI bus 108 which is controlled by the PCI interface section 107. The PCI bus 108 has a detachable slot in the case where various extended circuits are necessary. In this embodiment, a xDSL modem 110 is attached to this slot so as to compose one portion of the information processing apparatus 100.

The CPU 101 controls the whole information processing apparatus 100, and executes various data processes. The CPU 101 loads programs retained in the storage device 103 into the memory 102, and executes these programs so that various functions (for example, electric power control function, communication function via the xDSL modem 110) are realized.

The electric power control function controls electric powers of not only the CPU 101 but also the whole information processing apparatus 100. In the information processing apparatus 100, a residue of a power in a battery (or voltage) is estimated by this electric power control function, and a plurality of operating modes whose dissipation powers are different are used properly according to this residue or the like. As the operating modes, two modes, that is, a normal mode and an electricity-saving mode are provided. The electricity-saving mode is an operating mode which limits some functions and operations whose priorities are low so as to lower a dissipation power in the whole information processing apparatus 100 (at least lower than the normal mode). In the electricity-saving mode, for example, an operating frequency of the CPU 101 is lowered. Moreover, not only the CPU 101 but also the operating states of the storage device 103 and the xDSL modem 110 are controlled so that these dissipation powers are lowered. This electricity-saving mode is used in the case where a residue of the power in a battery is small (or a voltage is low) On the contrary, the normal mode is an operating mode which can execute all functions, operations and the like without limitation. This normal mode is used in the case where a residue of a battery is enough or in the case where a power is supplied from an AC power source. Since such a power control function is a well-known technique, the detailed description thereof is omitted.

In addition, the communication function is for that the CPU 101 controls the xDSL modem 110 via the PCI interface section 107 and the PCI bus 108 so as to communicate data with an opposite side (for example, base station side) being connected via a communication line 150. At the time of communication, various processes are executed by the CPU 101 itself or by controlling the xDSL modem 101 or the like. The process by means of this communication function is divided into a processing operation on the receiving side and a processing operation on the transmission side. For example, as for initialization which is executed at the time of starting the communication, in the processing operation on the receiving side, a line condition (S/N) is checked and a transmission rate is determined according to the checked result. Moreover, a function for actually setting the transmission rate determined in such a manner, namely, a bit map which defines transmission rates for each carrier on a DMT system is created. Meanwhile, as the processing operation as the transmission side, predetermined data or the like for making the S/N measurement on the receiving side are transmitted. In this embodiment, the CPU 101 executes both the processing operations in order to execute two-way communication.

The present embodiment adopts a dual bit map system, and two kinds of bit maps (FEXT-use bit map, and NEXT-use bit map) are created for communication in a certain one direction (up direction or down direction). Therefore, different transmission rates can be set at an interval that the transmission rate is likely to be lowered (namely, NEXT interval) and at an interval that the transmission rate can be set to be higher (namely, FEXT interval). Particularly in this embodiment, how to decide the transmission rate at the interval that the transmission rate is likely to be low (namely, NEXT interval) is different according to the above-mentioned operating modes. Namely, in the normal mode, since a usable power is enough, the data transmission is executed even at NEXT interval so that higher-speed transmission is attempted to be realized. The data transmission rate in this case is a value according to the result of the S/N measurement in initialization. Meanwhile, in the electricity-saving mode, data transmission is stopped at NEXT interval so that the efficient transmission is possible from the viewpoint of power consumption, and transmission is executed only at the interval that the transmission rate is high (namely, FEXT interval).

Since the dual bit map system where individual bit maps are used at NEXT interval and FEXT interval is a well-known art, the detailed description thereof is omitted. The dual bit map system is disclosed in, for example, Japanese Patent Application Laid-Open No. 2000-151742.

The storage device 103 retains various programs which are executed by the CPU 101 and data to be transmitted and received. The storage device 103 is concretely composed of a hard disc apparatus or a magneto-optical disc apparatus, and a non-volatile memory such as a flash memory or a read-only storage medium such as CD-ROM or a volatile memory such as RAM (Random Access Memory) or a combination of them.

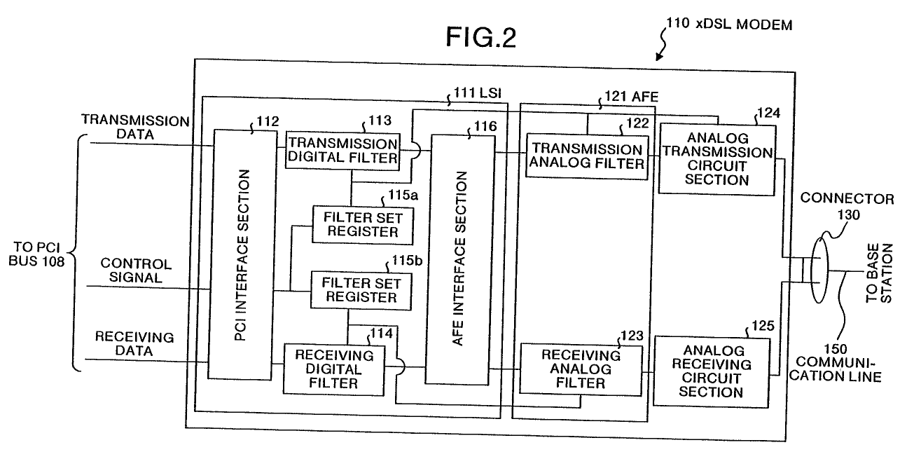

There will be explained below a structure of the xDSL modem 110 with reference to FIG. 2.

As shown in FIG. 2, the xDSL modem 110 is composed of an LSI 111, an AFE 121, an analog transmission circuit section 124, an analog receiving circuit section 125 and a connector 130.

The LSI 111 controls the whole xDSL modem 110 according to a control signal or the like input via the PCI bus 108, and processes data transmitted/received via the communication line 150. The LSI 111 is concretely composed of a PCI interface section 112, a transmission digital filter 113, a receiving digital filter 114, a filter set registers 115a and 115b, and an AFE interface section 116.

The PCI interface section 112 controls connection with the PCI bus 108 and transmission/receiving of various data. All various control signals for the LSI 111 and data to be transmitted and received are input/output into/from the LSI 111 via the PCI interface section 112.

The transmission digital filter 113 processes data for transmission (digital signal). More concretely, it is constituted so as to include an IIR filter or the like. An operating state (operation/stop) of the transmission digital filter 113 can be set according to contents written into the filter set register 115a, mentioned later.

The receiving digital filter 114 processes a signal (receiving data) transmitted via the communication line 150. More concretely, it is constituted so as to include an IIR (Infinite-duration Impulse Response) filter, an FIR (Finite-duration Impulse Response) filter and the like. An operating state (operation/stop) of the transmission digital filter 113 can be set according to contents written into the filter set register 115b, mentioned later.

The filter set registers 115a and 115b retain information for setting the operating states and the like of the respective sections of the xDSL modem 110. More concretely, the filter set register 115a retains information for setting the operating states of transmission filters (the transmission digital filter 113 and a transmission analog filter 122) and information for setting a state of supplying an electric power to the analog transmission circuit section 124. Meanwhile, the filter set register 115b retains information for setting the operating states of the receiving filters (the receiving digital filter 114 and a receiving analog filter 123). The contents of the filter set registers 115a and 115b are rewritable by CPU 101 according to control signals to be input via the PCI interface section 112, the PCI bus 108 and the like. In the present embodiment, the contents of the filter set registers 115a and 115b are rewritten as the need arises so that the transmission digital filter 113 and the like is stopped and the dissipation power is suppressed.

The AFE interface section 116 intervenes between the LSI 111 as a digital circuit and the AFE 121 composed of an analog circuit. The AFE interface section 116 is composed so as to convert transmission data (digital signal) which were processed by the transmission digital filter 113 into an analog signal according to the AFE 121. On the contrary, the AFE interface section 116 converts receiving data (analog signal) which were processed by the receiving analog filter 123 into a digital signal according to the receiving digital filter 114.

The AFE (Analog Front End) 121 is composed of the transmission analog filter 122 and the receiving analog filter 123.

The transmission analog filter 122 processes data for transmission. This transmission analog filter 122 is constituted so that its operating state (operation/stop) changes according to the contents written into the filter set register 115a.

The receiving analog filter 123 processes data (receiving data) transmitted via the communication line 150. This receiving analog filter 123 is constituted so that its operating state (operation/stop) changes according to the contents written into the filter set register 115b.

The analog transmission circuit section 124 controls transmission power spectrum of a signal (transmission signal) to be sent to the communication line 150. This analog transmission circuit section 124 is constituted so as to include a capacitor or the like. Moreover, the analog transmission circuit section 124 is constituted so as to include a switch for turning ON/OFF supply of an electric power to the analog transmission circuit section 124. This switch is constituted so that its state (ON/OFF) changes according to the contents of the filter set register 115a. Therefore, the switch is turned OFF so that the analog transmission circuit section 124 is stopped and the dissipation power can be suppressed.

The analog receiving circuit section 125 adjusts gain of a signal (receiving signal) sent via the communication line 150. The analog receiving circuit section 125 is always in the operating state when an electric power is supplied to the xDSL modem 110.

The connector 130 is connected to the communication line 150. A frequency bandwidth of a signal to be used for communication in the up direction and a frequency bandwidth of a signal to be used for communication in the down direction are different from each other so that the communication line 150 composed of one set of metal wirings (two) executes the two-way communication. For this reason, a signal line which connects the analog transmission circuit section 124 and the connector 130, and a signal line which connects the analog receiving circuit section 125 and the connector 130 are connected with each other in mid course.

The electric power for operating the xDSL modem 110 is supplied via the PCI bus 108.

The information processing apparatus 100 mentioned here is an apparatus which is basically assumed to be used by a general user, but the opposite side in actual communication, namely, the base station side has also the structure which is approximately similar to the information processing apparatus 100 basically. However, the apparatus on the base station side transmits data transmitted from the information processing apparatus 100 to another base station, and the data to be transmitted to the information processing apparatus 100 are data transmitted via another base station.

The operation will be explained below.

In the explanation here, the structure of the apparatuses on the base station side is similar to that shown in FIGS. 1 and 2. In this case, in order to ease discrimination between the structure of the receiving side apparatus and the structure of the transmission side apparatus, in the following explanation, “(r)” is given to symbols in the structure of the receiving side apparatus, whereas “(t)” is given to symbols in the structure of the transmission side apparatus.

The contents of the communication operation in the up (general user to base station) and down (base station to general user) directions are basically the same as each other. Therefore, the following explanation describes the case where data are transmitted to a certain direction without discriminating between the up and down directions. In the following explanation, a CPU 101 (r) on the receiving side corresponds to an apparatus on the general user side in the case of the down direction, and it corresponds to an apparatus on the base station in the case of the up direction. Meanwhile, the CPU 101 (t) on the transmission side corresponds to the apparatus on the base station side in the case of the down direction, and it corresponds to the apparatus on the general user side in the case of the up direction.

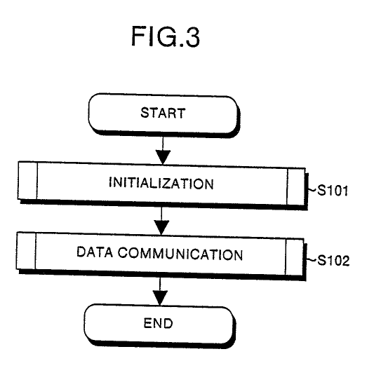

At first, an outline of the communication operation will be explained with reference to FIG. 3.

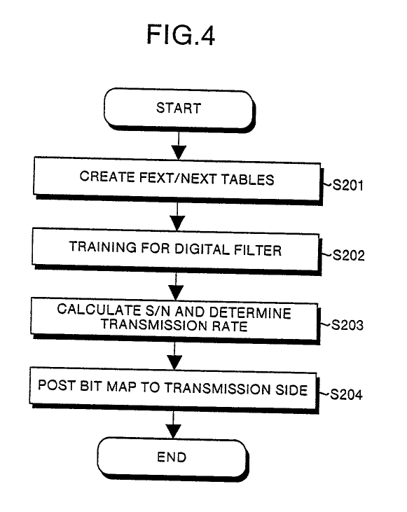

At the time of starting communication, the apparatuses on the receiving and transmission sides execute initialization so as to determine a transmission rate of data (step S101). This initialization will be detailed later with reference to FIG. 4.

After the initialization is ended, actual data communication is started (step S102). In this case, the transmission side and receiving side execute a communication process at the transmission rate which is determined based on a bit map created by the initialization. Namely, the receiving side executes the receiving process assuming that data are transmitted at the transmission rate according to the bit map created by the initialization. Meanwhile, the transmission side transmits data at the transmission rate according to the bit map posted from the receiving side. Since the dual bit map system is used here, the transmission rates are different at FEXT interval and NEXT interval.

Next, there will be explained below an outline of the initialization with reference to FIG. 4. Here, the description will be given mainly as to processing contents on the receiving side. The process shown in FIG. 4 is executed at the stage of step S101 in FIG. 3.

At the time of the initialization, the CPU 101 (t) on the transmission side operates the xDSL modem 110 (t) so as to transmit predetermined data or the like via the communication line 150. Meanwhile, the xDSL modem 110 (r) on the receiving side receives the transmitted data and outputs them to the CPU 101 (r) via the PCI bus 108 (r) or the like. Accordingly, the CPU 101 (r) on the receiving side executes the following process.

At first, the CPU 101 (r) on the receiving side executes gain adjustment of the analog receiving circuit section 125 (r), reference phase detection and the like for the signal input from the xDSL modem 110 (r) so that a symbol pattern table (FEXT/NEXT table) is created (step S201). This process concretely corresponds to AGC sequence and A48 sequence in the standard G. 992.2 of xDSL.

Thereafter, the CPU 101 (r) on the receiving side trains for the digital filters (the transmission digital filter 113 (r) and the receiving digital filter 114 (r)) (step S202) This process corresponds to C-REVERB*1 and 2 sequence in the standard G.992.2.

Thereafter, the CPU 101 (r) calculates S/N of a signal received by the xDSL modem 110 (r) and determines the transmission rate based on the calculated result. A bit map is created according to the determined transmission rate (step S203). This process corresponds to C-MEDLEY sequence in the standard G.992.2.

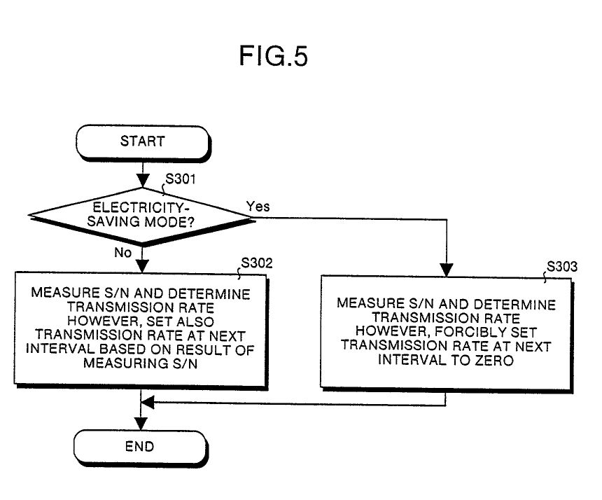

In this embodiment, in the case where the apparatus on the receiving side is in the electricity-saving mode, the transmission rate at NEXT interval (on the receiving side) is forcibly set to zero regardless of the result of measuring S/N. This is because the data are prevented from being transmitted at NEXT interval. The process at step S203 will be detailed later with reference to FIG. 5.

Thereafter, the CPU 101 (r) on the receiving side controls the xDSL modem 110 (r) so as to post the bit map created in such a manner to the transmission side via the communication line 150 (step S204). This process corresponds to C-MSG RATES sequence in the standard G.992.2.

Next, there will be detailed below the process at step S203 in FIG. 4 with reference to FIG. 5.

The electric power control function always works in the apparatus on the receiving side, and the operating mode is set automatically or manually by an instruction from a user.

At step S301, the CPU 101 (r) on the receiving side judges as to whether or not the electricity-saving mode is specified at that time. As a result of the judgment, when the electricity-saving mode is not specified, the transmission rate at NEXT interval is determined according to the result of measuring S/N (step S302). As a result, the data are transmitted also at NEXT interval although the transmission rate is low.

Meanwhile, as a result of the judgment at step S301, when the electricity-saving mode is specified, the CPU 101 (r) determines the transmission rate to zero regardless of the result of measuring S/N so that the data are not received at NEXT interval (step S303).

As not shown in the drawing, at steps S302 and S303, the transmission rate at FEXT interval is also determined. However, differently from NEXT interval, the transmission rate is not forcibly set to zero at FEXT interval according to the operating mode. This transmission rate always has a value according to the result of measuring S/N.

Concretely, the transmission rate determined in such a manner is set in such a manner that the CPU 101 (r) on the receiving side sets the bit maps (NEXT-use bit map and FEXT-use bit map) into a state according to the transmission rate.

After step S302 or S303, the sequence goes to step S204 in FIG. 4.

There will be explained below an operation on the transmission side during data communication.

The following process is executed at the stage of step S102 in FIG. 3.

The CPU 101 (t) on the transmission side transmits data at the transmission rate which is defined in the posted bit map created on the receiving side. In the case where the transmission rate is set to zero in the NEXT-use bit map, data are not transmitted at NEXT interval. In the case where it is set that data are transmitted at NEXT interval, data are transmitted at NEXT interval according to the setting of the NEXT-use bit map. However, since the state of a line is generally bad at NEXT interval, the transmission rate mostly becomes low. Similarly at FEXT interval, data are transmitted at the transmission rate defined in the FEXT-use bit map. However, as for the FEXT-use bit map, the bit map is not forcibly set to zero.

In the case where the apparatus on the receiving side is in the electricity-saving mode in such a manner, data are transmitted only at FEXT interval (receiving side), namely, only at an interval that the transmission rate can be set to be higher. While the transmission of data is stopped, since the transmission process on the transmission side and the receiving process on the receiving side are not executed, the power consumption amount is lowered. In such a manner, high efficiency can be realized from the viewpoint of the energy efficiency.

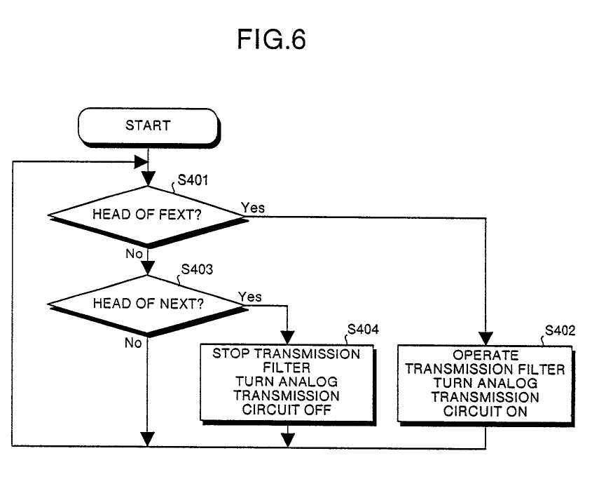

Further, in this embodiment, in the case where the transmission rate is set to zero at NEXT interval, the CPU 101 (t) on the transmission side stops the operations of the respective sections of the xDSL modem 110 (t) at the time of NEXT interval (on the receiving side) so that the power consumption is suppressed. There will be explained below this process with reference to FIG. 6.

The CPU 101 (t) on the transmission side judges as to whether or not the time during communication is a head of FEXT interval (step S401). As a result of the judgment, when the time is the head of FEXT interval, the sequence goes to step S402.

The NEXT interval/FEXT interval are determined based on only the state of the receiving side. Therefore, fundamentally the detection and judgment at the NEXT interval/FEXT interval can be made only on the receiving side. However, in the two-way communication, both the user side and the base station are transmission side and simultaneously receiving side. Namely, the up direction on the user side is the transmission side and simultaneously a receiving side in the down direction. Moreover, the states of NEXT/FEXT are always opposite to those of the communicating opposite side. Therefore, the states (NEXT/FEXT) on this side are detected and judged so that the states of the opposite side can be known indirectly. The detection and judgment at NEXT interval/FEXT interval are made actually by counting a number of DMT symbols transmitted from the transmission side. Since this point is a well-known art, the description thereof is omitted. This is disclosed in, for example, Japanese Patent Application Laid-Open No. 2000-151742.

At step S402, the CPU 101 (t) on the transmission side sets the content of the filter set register 115a (t) to a predetermined value so as to actuate the transmission filters (transmission digital filter 113 (t) and the transmission analog filter 122 (t)). Moreover, similarly the analog transmission circuit section 124 (t) is turned ON. As a result, the data transmission is possible. After step S402, the sequence returns to step S401.

Meanwhile, as a result of the judgment at step S401, when that time is not a head of FEXT interval, the sequence goes to steps S403. At step S403, the CPU 101 (t) judges as to whether or not that time is a head of NEXT interval. As a result of the judgment, when the time is the head of the NEXT interval, the sequence goes to step S404.

At step S404, the CPU 101 (t) sets the content of the filter set register 115a (t) to a predetermined value so as to stop the transmission digital filter 113 (t) and the transmission analog filter 122 (t). Moreover, similarly, the analog transmission circuit section 124 (t) is turned OFF. In this case, since the transmission rate at NEXT interval is set to zero, even if their operations are stopped, there arises no problem. After step S404, the sequence returns to step S401.

As a result of the judgment at step S403, when that time is not a head of NEXT interval, the sequence returns directly to step S401.

The CPU 101 (t) on the transmission side continues to always repeat the process shown in FIG. 6 during data transmission. However, as mentioned before, the process of FIG. 6 is executed only in the case where the transmission rate is set to zero at NEXT interval. In the other cases, the operations of the transmission digital filter 113 (t) and the like are not stopped.

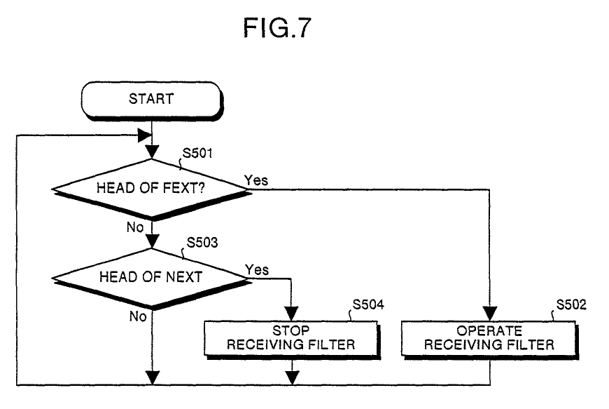

Next, there will be explained below an operation on the receiving side during data transmission with reference to FIG. 7.

The process mentioned below is executed at the stage of step S102 in FIG. 3.

The CPU 101 (r) on the receiving side operates the xDSL modem 110 (r) so as to execute the receiving process. This process is executed assuming that data are transmitted at the transmission rate defined in the bit map created by the CPU 101 (r).

Further, in this embodiment, in the case where the transmission rate is set to zero at NEXT interval, the CPU 101 (r) on the receiving side stops the operations of the respective sections of the xDSL modem 110 (r) at NEXT interval so that the power consumption is suppressed. There will be explained below this process with reference to FIG. 7.

The CPU 101 (r) on the receiving side judges as to whether or not communication time is a head of FEXT interval during communication (step S501). As a result of this judgment, when the time is the head, the sequence goes to step S502.

At steps S502, the CPU 101 (r) on the receiving side sets the content of the filter set register 115b (r) so as to operate the receiving filters (the receiving digital filter 114 (r) and the receiving analog filter 123 (r)). As a result, the xDSL modem 110 (r) on the receiving side is brought into a state that it can process the receiving data. After step S502, the sequence returns to step S501.

Meanwhile, as a result of the judgment at step S501, when the time is not the head of FEXT, the sequence goes to step S503. At step S503, the CPU 101 (r) judges as to whether or not the time is the head of NEXT interval. As a result of this judgment, when the time is the head of NEXT interval, the sequence goes to step S504.

At step S504, the CPU 101 (r) sets the filter set register 115b (r) to a predetermined value so as to stop the receiving filters (the receiving digital filter 114 (r) and the receiving analog filter 123 (r)). As a result, the power consumption can be suppressed. Here, since data are not transmitted at NEXT interval, if they are stopped, there arises no problem. After step S504, the sequence returns to step S501.

As a result of the judgment at step S503, when the time is not the head of NEXT interval, the sequence returns directly to step S501.

The CPU 101 (r) on the receiving side continues to always repeat the process shown in FIG. 7 during data communication.

However, as mentioned above, the process of FIG. 7 is executed only in the case where the transmission rate is set to zero at NEXT interval. In the other cases, the operations of the receiving digital filter 114 (r) and the like are not stopped.

As mentioned above, in the first embodiment, the transmission of data is stopped at NEXT interval so that the efficient data transmission (communication) is possible from the viewpoint of energy efficiency.

In addition, in this embodiment, since such a control is made according to the operating modes (normal mode/electricity-saving mode), the operating time can be lengthened in an information processing apparatus (for example, notebook type personal computer) which is operated by a battery as a power supply, and thus this embodiment is particularly practicable.

An information processing apparatus of the second embodiment realizes data transmission with high energy efficiency similarly to the first embodiment. Particularly, the second embodiment is mainly characterized in that when S/N is measured in initialization, the transmission side transmits abnormal data and the receiving side is made to mis-recognize that a situation of a line is very bad so that a transmission rate at NEXT interval is made to be zero deliberately.

This second embodiment is different in the processing contents at the time of initialization from the first embodiment. The other points are basically similar to the first embodiment. The following explanation refers mainly to different points with the first embodiment. As for the portions of the functional structure which are the same as those in the first embodiment, the same reference numerals are given to them, and the description thereof is omitted.

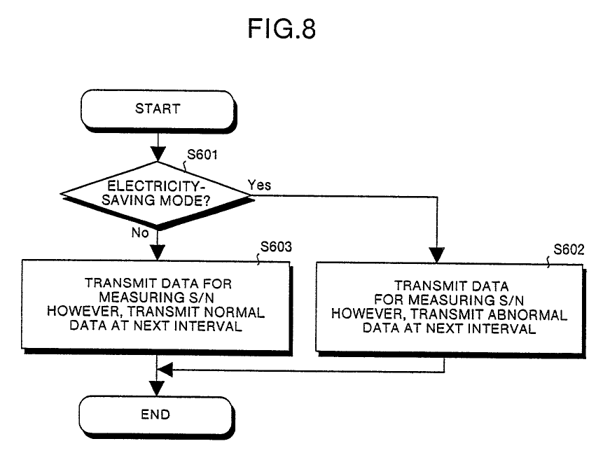

At first, there will be explained below contents of the processing operation on the receiving side at the time of initialization with reference to FIG. 8.

The process shown in FIG. 8 is executed on the transmission side at the stage corresponding to step S203 of FIG. 4.

The CPU 101 (t) on the transmission side judges as to whether or not the electricity-saving mode is specified (step S601). As a result of the judgment, in the case where the electricity-saving mode is specified, in C-MEDLEY sequence, abnormal data are transmitted as data for measuring S/N at NEXT interval (step S602). The abnormal data here are data which cannot be received (or cannot be recognized) on the receiving side (for example, random data). Such abnormal data are transmitted, thereby making the receiving side deliberately mis-recognize that the situation of the line is very bad.

Meanwhile, as a result of the judgment at step S601, when the electricity-saving mode is not specified, the CPU 101 (t) transmits normal data as data for measuring S/N in C-MEDLEY sequence at NEXT interval (step S603).

As not shown in the drawing, at steps S602 and S603, the CPU 101 (t) transmits data for measuring S/N similarly also at FEXT interval. However, differently from NEXT interval, normal data are always transmitted at FEXT interval.

Next, there will be explained below contents of the processing operation on the receiving side at the time of initialization with reference to FIG. 4. This process is executed at the stage of step S101 in FIG. 3.

At the time of initialization, the CPU 101 (t) on the transmission side operates the xDSL modem 110 (t) and the like so as to transmit predetermined data or the like via the communication line 150. Meanwhile, the xDSL modem 110 (r) on the receiving side detects this transmitted signal (data) and outputs the signal to the CPU 101 (r) via the PCI bus 108 (r) and the like. Accordingly, the CPU 101 (r) on the receiving side executes the following process.

At first, the CPU 101 (r) adjusts gain and detects a reference phase of the analog receiving circuit section 125 (r) so as to create a symbol pattern table (FEXT/NEXT table) (step S201). Concretely, this process corresponds to AGC sequence and A48 sequence in the standard G.992.2 of xDSL.

Thereafter, the CPU 101 (r) makes the digital filters (the transmission digital filter 113 (r) and the receiving digital filter 114 (r) ) execute training (step S202). This process corresponds to C-REVERB*1 and 2 sequences in the standard G.992.2.

After the process at step S202 is completed, predetermined data for measuring S/N are transmitted from the transmission side. As explained before with reference to FIG. 7, the data transmitted at this time differ with the operating mode on the transmission side. When the CPU 101 (t) on the transmission side is in the normal mode, normal data are transmitted. Meanwhile, when the CPU 101 (t) is in the electricity-saving mode, abnormal data (for example, unreceivable random data) are transmitted.

The CPU 101 (r) on the receiving side calculates S/N of the signal received at this time, and determines a transmission rate based on the calculated result. A bit map is created according to the determined transmission rate (step S203). In this second embodiment, differently from the process at step S203 of the first embodiment, the CPU 101 (r) on the receiving side always sets a transmission rate at NEXT interval (on the receiving side) based on the result of measuring S/N. As a result, in the case where normal data are transmitted from the transmission side, the transmission rate according to the actual line condition is set at NEXT interval. Meanwhile, in the case where data are transmitted from the transmission side, the CPU 101 (r) on the receiving side judges that the line condition is very bad at NEXT interval. For this reason, in this case, the transmission rate is set to zero at NEXT interval.

Thereafter, the CPU 101 (r) on the receiving side posts this bit map to the transmission side (step S204). This process corresponds to C-MSG·RATES sequence in the standard G.992.2.

Since the operation during data communication is similar to that in the first embodiment (see FIGS. 6 and 7), the description thereof is omitted.

As explained above, in this second embodiment, the transmission rate can be set to zero by positively operating from the transmission side. Therefore data transmission with higher energy efficiency can be realized.

In addition, in this embodiment, since such a control is made according to the operating mode (normal mode/electricity-saving mode), operating time in an information processing apparatus (for example, a notebook type personal computer) which is operated by a battery as a power supply can be lengthened, and this embodiment is particularly practicable.

In the above-mentioned first and second embodiments, only when the apparatus on the receiving side or the transmission side is set into the electricity-saving mode, data transmission or the like is stopped at NEXT interval. However, data transmission or the like may be always stopped at NEXT interval regardless of the operating mode. As a result, communication with higher energy efficiency can be realized.

In the above-mentioned first and second embodiments, the operating mode (electricity-saving mode/normal mode) is used as a reference as to whether or not data transmission is stopped at NEXT interval. However, this reference is not limited to this. For example, the reference may be whether or not the power supply is a battery (or AC power supply). In this case, in the case where the power supply is a battery (namely, an electricity energy to be capable of being supplied is limited), data transmission is stopped at NEXT interval. Further, the first and second embodiments are practicable for the case or the like where the apparatus is operated by an emergency power supply to be used at the time of service interruption, accidents and the like (for example, a private electric generator).

The structure of the first embodiment may be combined with the structure of the second embodiment. As a result, since a dissipation power can be suppressed in both transmission and receiving, the energy efficiency is higher. The operable time can be further lengthened in a battery-driven apparatus.

The objects to which the present invention is applied are not limited to a noise due to ISDN and the xDSL technique. The structure of the present invention (particularly, the structure that the transmission rate is forcibly set to zero at the interval that the transmission rate becomes low due to high noise level) can be widely applied to communication in a periodical noise environment that a level of the noise changes periodically.

The programs which realize the above-mentioned various functions may be recorded in a recording medium which can be read by a computer. In this case, the programs recorded in the recording medium are read into a computer system (in the above embodiments, the information processing apparatus 100) as the need arises and are executed so as to realize the above-mentioned various processes.

The “computer system” here includes hardware such as Os and peripheral equipments. Moreover, the “computer-readable recording medium” is a floppy disc, a magneto-optical disc, ROM or CD-ROM which is a portable medium, or a recording device such as a hard disc contained in the computer system. Further, the “computer-readable recording medium” includes a recording medium which dynamically retains programs for a short time such as a communication line in the case where programs are transmitted via a communication line such as a network as internet or a telephone line, and a recording medium which retains programs for constant time such as a volatile memory inside the computer system to be a server or a client. Moreover, the programs may realize a part of the above functions, or can may realize the above functions with a combination of programs already recorded in the computer system.

As mentioned above, according to this invention, the data transmission is stopped at the interval that the data transmission rate is low, and the data transmission is executed only at the interval that the data rate is high so that the data transmission with high energy efficiency can be realized. Moreover, when data are not transmitted, filter group or the like of a signal converting device are stopped so that wasteful power consumption can be suppressed. Such an effect is practicable for the case where the power supply capacity (usable power) is limited, for example, particularly a notebook type personal computer which is driven by a battery.

In addition, since details for determining the transmission rate (as to whether or not the transmission rate at the interval that the noise level is high is set uniformly to zero) according to the operating mode or the like, data can be transmitted at higher speed in the case where an electric power is sufficient. Therefore, the transmission speed is not uniformly lowered. According to the situation of a power supply or the like, the data transmission with priority of transmission speed and the data transmission with priority of energy efficiency can be used properly.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A data transmission apparatus for receiving data transmitted via a line under a noise environment in which two time spaces having different noise levels appear alternatively, said data transmission apparatus comprising:
a measuring unit which measures a state of the line;
a transmission rate determining unit which determines a transmission rate based on the measured result of the measuring unit at an interval of the intervals that the noise level is low, whereas determining the transmission rate as zero at an interval that the noise level is high;
a posting unit which posts the transmission rate determined by the transmission rate determining unit to a transmission side; and
a receiving unit which receives data transmitted via the line at the transmission rate determined by the transmission rate determining unit.

2. The data transmission apparatus according to claim 1, wherein, when a predetermined condition is satisfied, the transmission rate determining unit determines the transmission rate based on the measured result of the measuring unit also at the interval that the noise level is high.

3. The data transmission apparatus according to claim 2, wherein the condition relates to a state of a power supply of the data transmission apparatus or a state which is changed in response to the state of the power supply.

4. The data transmission apparatus according to claim 3, wherein the power supply is a battery.

5. A data transmission apparatus for transmitting desired data via a line under a noise environment in which two time spaces having different noise levels appear alternatively, said data transmission apparatus comprising:
a measuring signal transmission unit which, at the time of starting communication, transmits a predetermined receivable signal at an interval that the noise level is low, whereas transmitting abnormal unreceivable data at an interval that the noise level is high to a receiving side via the line as a measuring signal; and
a transmission unit which transmits data to be transmitted at a transmission rate posted from the receiving side via the line.

6. The data transmission apparatus according to claim 5, wherein, when a predetermined condition is satisfied, the measuring signal transmission unit transmits the predetermined receivable signal as the measuring signal also at the interval that the noise level is high.

7. The data transmission apparatus according to claim 6, wherein the condition relates to a state of a power supply of the data transmission apparatus or a state which is changed in response to the state of the power supply.

8. The data transmission apparatus according to claim 7, wherein the power supply is a battery.

9. A data transmission method under a noise environment in which two time spaces having different noise levels appear alternatively, the data transmission method comprising the steps of:
evaluating a level of a noise at an interval that the noise level is low and transmitting data at a transmission rate which is determined based on the evaluated result; and
setting the transmission rate to zero at an interval that the noise level is high so as not to transmit data.

10. A data transmission method of receiving data transmitted via a line under a noise environment in which two time spaces having different noise levels appear alternatively, the data transmission method comprising the steps of:
measuring a state of the line;
determining a transmission rate based on the measured result at an interval of the intervals that the noise level is low, whereas determining the transmission rate as zero at an interval that the noise level is high;
posting the determined transmission rate to a transmission side; and
receiving data at the transmission rate posted to the transmission side.

11. The data transmission method according to claim 10, wherein, when a predetermined condition is satisfied, the transmission rate is determined based on the measured result also at the interval that the noise level is high.

12. The data transmission method according to claim 11, wherein the condition relates to a state of a power supply on a receiving side or a state which is changed in response to the state of the power supply.

13. A data transmission method of transmitting a measuring signal at the time of starting communication in a noise environment in which two time spaces having different noise levels appear alternatively and measuring this signal so as to measure a condition of a line and transmitting data at transmission rates determined for each interval based on the measured result, wherein,
at the time of the measurement, a predetermined receivable signal is transmitted at an interval that the noise level is low, whereas abnormal unreceivable data are transmitted at an interval that the noise level is high.

14. A data transmission method of transmitting data via a line under a noise environment in which two time spaces having different noise levels appear alternatively, wherein,
at the time of starting communication, a transmission side transmits a predetermined receivable signal at an interval that the noise level is low, whereas transmits abnormal unreceivable data are transmitted at an interval that the noise level is high via the line as a measuring signal; and
the transmission side transmits data via the line at a transmission rate posted from the receiving side.

15. The data transmission method according to claim 14, wherein, when a predetermined condition is satisfied, the receivable signal which is predetermined is transmitted also at the interval that the noise level is high as the measuring signal.

16. The data transmission method according to claim 15, wherein the condition relates to a state of a power supply on the transmission side or a state which is changed in response to the state of the power supply.

17. A computer readable medium for storing instructions, which when executed on a computer, causes the computer to perform data transmission method under a noise environment in which two time spaces having different noise levels appear alternatively, the data transmission method comprising the steps of:
evaluating a level of a noise at an interval that the noise level is low and transmitting data at a transmission rate which is determined based on the evaluated result; and
setting the transmission rate to zero at an interval that the noise level is high so as not to transmit data.

18. A computer readable medium for storing instructions, which when executed on a computer, causes the computer to perform a data transmission method of receiving data transmitted via a line under a noise environment in which two time spaces having different noise levels appear alternatively, the data transmission method comprising the steps of:
measuring a state of the line;
determining a transmission rate based on the measured result at an interval of the intervals that the noise level is low, whereas determining the transmission rate as zero at an interval that the noise level is high;
posting the determined transmission rate to a transmission side; and
receiving data at the transmission rate posted to the transmission side.

19. A computer readable medium for storing instructions, which when executed on a computer, causes the computer to perform data transmission method of transmitting a measuring signal at the time of starting communication in a noise environment in which two time spaces having different noise levels appear alternatively and measuring this signal so as to measure a condition of a line and transmitting data at transmission rates determined for each interval based on the measured result, wherein,
at the time of the measurement, a predetermined receivable signal is transmitted at an interval that the noise level is low, whereas abnormal unreceivable data are transmitted at an interval that the noise level is high.

20. A computer readable medium for storing instructions, which when executed on a computer, causes the computer to perform data transmission method of transmitting data via a line under a noise environment in which two time spaces having different noise levels appear alternatively, wherein,
at the time of starting communication, a transmission side transmits a predetermined receivable signal at an interval that the noise level is low, whereas transmits abnormal unreceivable data are transmitted at an interval that the noise level is high via the line as a measuring signal; and
the transmission side transmits data via the line at a transmission rate posted from the receiving side.

21. A computer program causes the computer to perform data transmission method under a noise environment in which two time spaces having different noise levels appear alternatively, the data transmission method comprising the steps of:
evaluating a level of a noise at an interval that the noise level is low and transmitting data at a transmission rate which is determined based on the evaluated result; and
setting the transmission rate to zero at an interval that the noise level is high so as not to transmit data.

22. A computer program causes the computer to perform a data transmission method of receiving data transmitted via a line under a noise environment in which two time spaces having different noise levels appear alternatively, the data transmission method comprising the steps of:
measuring a state of the line;
determining a transmission rate based on the measured result at an interval of the intervals that the noise level is low, whereas determining the transmission rate as zero at an interval that the noise level is high;
posting the determined transmission rate to a transmission side; and
receiving data at the transmission rate posted to the transmission side.

23. A computer program causes the computer to perform data transmission method of transmitting a measuring signal at the time of starting communication in a noise environment in which two time spaces having different noise levels appear alternatively and measuring this signal so as to measure a condition of a line and transmitting data at transmission rates determined for each interval based on the measured result, wherein,
at the time of the measurement, a predetermined receivable signal is transmitted at an interval that the noise level is low, whereas abnormal unreceivable data are transmitted at an interval that the noise level is high.

24. A computer program causes the computer to perform data transmission method of transmitting data via a line under a noise environment in which two time spaces having different noise levels appear alternatively, wherein,
at the time of starting communication, a transmission side transmits a predetermined receivable signal at an interval that the noise level is low, whereas transmits abnormal unreceivable data are transmitted at an interval that the noise level is high via the line as a measuring signal; and
the transmission side transmits data via the line at a transmission rate posted from the receiving side.
